(19) United States
(12) Patent Application Publication
(10) Pub. No.: US 2025/0217423 A1
(43) Pub. Date: Jul. 3, 2025

(54) Systems and Methods for Generating Benchmark Queries

(71) Applicant: GOOGLE LLC, Mountain View, CA (US)

(72) Inventors: Balaji Pattabhiraman, Karnataka (IN); Ujjwal Gupta, Delhi (IN); Ajinkya, Pradesh (IN); Rohit Jain, Mountain View, CA (US); Chien-Chen Chen, San Jose, CA (US); Josiah Katsutoshi Putman, Seattle, WA (US); Gautam Arakalgud, Santa Ana, CA (US); Divyanshu Ranjan, Bengaluru (IN); Yaxian Wang, Santa Clara, CA (US)

(21) Appl. No.: 18/601,007

(22) Filed: Mar. 11, 2024

Related U.S. Application Data
(60) Provisional application No. 63/615,493, filed on Dec. 28, 2023.

(51) Int. Cl. G06F 16/9532; G06F 11/34; G06F 16/954

(52) U.S. Cl. CPC G06F 16/9532; G06F 11/3428; G06F 16/954

(57) ABSTRACT

A method of facilitating content selection includes generating benchmark queries for a particular category. Generating the benchmark queries includes applying a text prompt as input to a language model trained on a knowledge base. The text prompt requests search queries indicative of user interest in the particular category. The method also includes selecting, responsive to new search queries entered by users, content items associated with the particular category for delivery to client devices of the users. Selecting the content items includes determining whether the new search queries correspond to the particular category at least in part by comparing the new search queries to a query set that includes the benchmark queries.

### CROSS-REFERENCE TO RELATED APPLICATIONS

This application claims the benefit of U.S. provisional patent application No. 63/615,493, filed on Dec. 28, 2023, the disclosure of which is hereby incorporated herein in its entirety.

### FIELD OF TECHNOLOGY

The present disclosure relates to user search queries and, more specifically, to selecting pertinent or useful content/results in response to user search queries.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In some systems that selectively provide content to users based on the users' search queries, a category (e.g., classification, type, vertical, etc.) is determined for each search query in order to select content that is likely of more interest to the user who entered the query. For example, the category may be a particular business category or vertical such as “personal injury lawyer” or “electrician,” and the relevant content may be a digital advertisement, description, and/or URL of a company associated with that vertical. Naturally, an accurate assessment of the search query category is generally needed to provide content that is more relevant to the current intent or interest of the user entering the search query. For example, a user entering a search query of “electricians near me” or “best electricians” is more likely to select an advertisement for electrician services. Conversely, a user entering a search query of “electrician insurance” or “electrician jobs” is more likely to be an electrician, or someone interested in becoming an electrician, and thus less likely to select such an advertisement.

To more accurately categorize a particular search query entered by a user, “benchmark” queries have been used. Benchmark queries are queries that are in some sense established as being highly relevant to a particular category. That is, benchmark queries for a particular category can represent “ground truth” queries that are known to be, or accepted as being, highly relevant to that category. When a new search query is the same as (or sufficiently similar to) a benchmark query, there is a higher level of confidence that the new query is associated with the same category as the benchmark query.

Typically, each category (e.g., each vertical) requires a rather large and diverse set of benchmark queries, to ensure that most search queries entered by people interested in the category are identified accordingly. For example, if a benchmark query set for the vertical “electrician services” only includes the two queries “electricians near me” and “best electricians,” the system might fail to classify a user search query “help with home wiring” as belonging to that vertical, despite the query being highly indicative of interest in such services. Thus, development of benchmark query sets can be a time-intensive and costly task, requiring individuals with some knowledge of the categories at issue to come up with numerous search queries that users interested in those categories are likely to enter. This can be particularly troublesome when there is a need to support an entirely new category in a relatively short amount of time (e.g., if an entity that facilitates the selection and delivery of digital advertisements decides to start supporting a new vertical). Even without time pressures, manually created benchmark query sets can lack diversity. For example, benchmark query sets might be under-inclusive and omit highly relevant queries if a person creating the queries fails to imagine, or simply does not know about, certain relevant terms or scenarios. Conversely, benchmark query sets might be over-inclusive if the person creating the queries fails to fully consider the applicability of certain queries to other categories. Thus, there is a need to create a benchmark query set faster and more efficiently, and to ensure that the constituent queries are sufficiently high-quality and diverse. Moreover, there is a need for systems and methods that can confirm that only appropriate, high-quality queries are included or maintained in the benchmark query set.

In addition, and irrespective of how benchmark queries are generated, there is a need to accurately match user search queries to other benchmark and/or other queries. Exact-match models, while simple, can often fail to match queries that should be similarly categorized. Moreover, while other models can do a better job of matching queries, they typically require a great deal of development. For example, a grammar-based model can be used to determine matches for a given set of benchmark queries, followed by an expansion using another semantic-exact model and a variety of other machine learning-based approaches. However, this overall process is very time consuming and cumbersome. For example, building the grammar-based model is a painstaking process requiring that the developer have a good understanding of both the relevant language (e.g., English, French, Spanish, etc.) and how such grammars are built.

### SUMMARY

Generally, in one aspect of the disclosed invention, a system generates queries of a benchmark query set for a particular category using a trained language model, such as a large language model (LLM). The language model may generate the queries using information such as general knowledge about the category (e.g., information about a particular vertical obtained from the Internet), service provider business profiles (e.g., company reviews, descriptions, etc.), service provider website content, user search queries that previously triggered the selection of content (e.g., digital ads) associated with the category, creatives associated with the category, organic search results for the search queries, and so on. This can provide a greater diversity of benchmark queries, and in a much shorter amount of time as compared to conventional methods.

In some implementations, to help ensure that each benchmark query set includes only high-quality queries (e.g., queries that will prove to be highly relevant to the category of a given query set), the system applies one or more evaluation criteria to each query generated by the language model. The criteria may include heuristic criteria such as the frequency with which the query is used, performance metrics when the query is used (e.g., measures of how often users entering the query go on to select content that is provided in response to their queries), and/or other criteria. In some implementations, humans can evaluate whether each benchmark query is truly relevant to a given category. Such evaluation criteria, and/or human review/evaluation, can further improve the metrics associated with the generated queries, such as precision and recall metrics. Other post-processing of generated queries may include, for example, location normalization, spelling correction, and so on.

Once generated, benchmark queries may be used at runtime to match incoming search queries (e.g., user queries entered via a search engine user interface) in various ways. In some implementations, for example, a system compares benchmark queries for a category to a large database of historical search queries in an “offline” manner (i.e., prior to runtime), and selects historical search queries that are sufficiently “similar” to the benchmark queries for inclusion in an expanded query list for the category. At runtime, the system can then compare new/incoming search queries to the expanded query list (i.e., determine similarity to one or more queries in the expanded query list), and to similar benchmark query sets and expanded query lists for other categories, to determine the appropriate category for the new search query. In other example implementations, the system instead compares only the benchmark queries for each category to new/incoming user queries at runtime, without first expanding the list based on historical user queries.

Another aspect of the disclosure relates to the manner in which a “match” is determined, regardless of whether, for example, benchmark queries (or queries of an expanded query set) are being matched against historical user search queries in an offline manner or are being matched against new/incoming user search queries at runtime (or both). The matching techniques disclosed herein can greatly simplify and expedite the overall process, such as by removing the need to build a grammar-based model as discussed above. Instead, a system can train one or more machine learning models to learn embeddings that project all queries, including both the benchmark queries (or an expanded query set that includes the benchmark queries) and the other search queries that are being compared to the benchmark (or expanded) queries, as vectors in a multi-dimensional space. The embeddings/vectors represent words or tokens in a manner that captures their meaning and context in the multi-dimensional space, such that queries that are more similar in meaning (and thus may correspond to more similar user intents) are closer to each other while queries that are less similar in meaning are further apart from each other.

In some implementations, the system identifies two queries as “matching” if the distance of their embeddings/vectors from each other (e.g., the dot product of the vectors) in the multi-dimensional space is less than a threshold distance. Optionally, the system may expand each query (benchmark or otherwise) before that query is input to a machine learning model, e.g., by mapping the terms/words of the query to one or more other terms known or otherwise determined to have some contextual association with the terms of the query. In some implementations, the system identifies which specific benchmark query a particular new or logged user search query is most similar to, in order to assign the new or logged query a particular sub-category (e.g., the sub-category of the benchmark query that is found to be most similar to the new or logged query). For example, the system may calculate cosine similarity metrics for this purpose (e.g., for ranking queries according to such metrics, and/or for comparison of such metrics against a minimum threshold, etc.).

In some implementations, the system divides search queries by language. For example, the feature set (input to the machine learning model) for each query may include an indication of the language of the query. In some implementations, to improve performance (i.e., processing efficiency and accuracy), the system ensures that queries of different languages are not compared to each other for matching purposes. For example, the system may map queries of each language to a different, respective multi-dimensional space, or may use the indicator of language for different queries to avoid computing distances for two queries of different languages.

In one aspect, a method of facilitating content selection includes: (1) generating, by a computing system, benchmark queries for a particular category, wherein generating the benchmark queries includes applying a text prompt as input to a language model trained on a knowledge base, and wherein the text prompt requests search queries indicative of user interest in the particular category; and (2) selecting, by the computing system and responsive to new search queries entered by users, content items associated with the particular category for delivery to client devices of the users, wherein selecting the content items includes determining whether the new search queries correspond to the particular category at least in part by comparing the new search queries to a query set that includes the benchmark queries.

In another aspect, a method of search query matching includes: (1) obtaining, by a computing system, first search queries and second search queries; (2) embedding, by the computing system and using one or more machine learning models, each query of the first search queries and the second search queries as a respective vector in a multi-dimensional space; (3) determining, by the computing system, distances between (i) the respective vector for each query of the first search queries and (ii) the respective vector for each query of the second search queries; and (4) mapping, by the computing system, each query of the second search queries to a respective one of the first search queries based at least in part on the distances.

### BRIEF DESCRIPTION OF THE DRAWINGS

FIG. 1 is a block diagram of an example system in which techniques for facilitating content selection can be implemented.

FIG. 2 depicts an example process for generating and using benchmark search queries.

FIGS. 3A and 3B depict example prompts that may be used to generate benchmark queries.

FIG. 4 depicts an example process for matching queries.

FIG. 5 depicts a simplified (reduced-dimensionality) representation of an example vector space for matching search queries.

FIG. 6 is a flow diagram of an example method for facilitating content selection.

FIG. 7 is a flow diagram of an example method for search query matching.

### DETAILED DESCRIPTION OF THE DRAWINGS

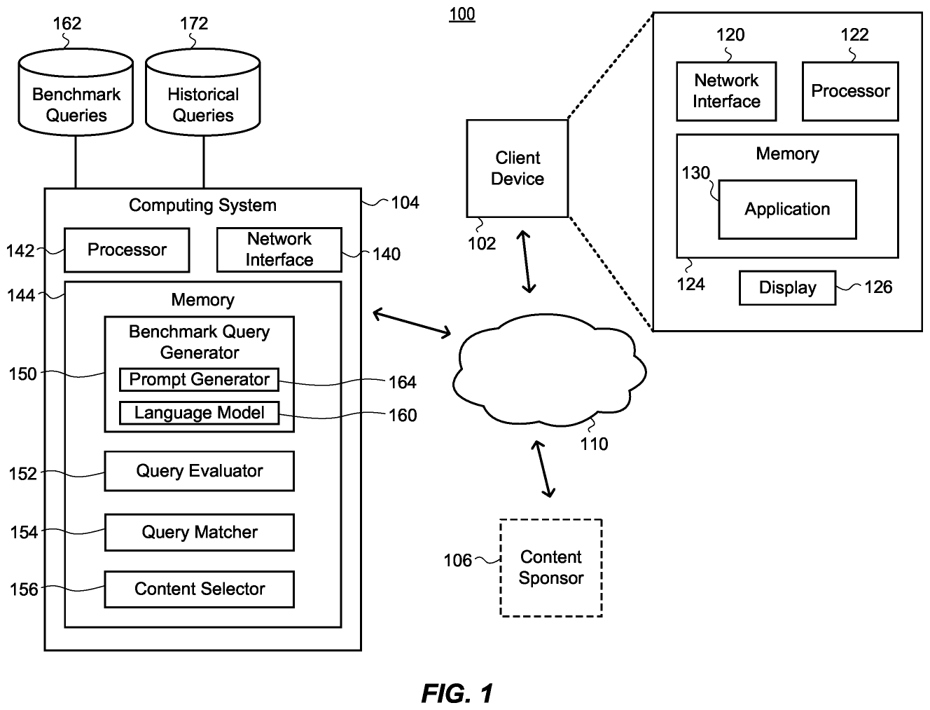

FIG. 1 is a block diagram of an example system 100 in which techniques for facilitating content selection can be implemented. The example system 100 includes a client device 102, a computing system 104, and a network 110. Optionally, the system 100 may also include a content sponsor 106 (e.g., a server of a service provider or other content sponsor). The computing system 104 is remote from the client device 102, and is communicatively coupled to the client device 102 via the network 110.

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 102, it is understood that the computing system 104 may also be in communication with a number (e.g., thousands or millions) of other client devices that are generally similar to the client device 102.

Generally, the client device 102 can access a search engine via a web page hosted by computing system 104, or via a search engine application (e.g., mobile application) that was previously installed on the client device 102. The search engine may be a search engine that identifies/provides web pages and/or other Internet content, such as, for example, a Google Search search engine. Alternatively, the search engine may be associated with the search functionality of any other web page or application, such as a video sharing platform (e.g., YouTube), a service-finding platform, and so on. In some implementations, the search engine is hosted by another server not shown in FIG. 1, and computing system 104 provides only some of the functionality discussed herein (e.g., benchmark query generation) without providing search engine functionality. However, it is understood that computing system 104 may itself include multiple servers and/or other devices (e.g., a computing device that generates benchmark queries and a separate, remote search engine server and/or ad server).

The computing system 104 generally categorizes search queries from client device 102, and uses the category or categories to select responsive content which computing system 104 (or possibly content sponsor 106) then sends to the client device 102. The responsive content may comprise traditional search query results (e.g., titles, summaries, partial web site content, and/or URLs) that the computing system 104 sends to client device 102 as links, where a selection of one such link by a user of client device 102 causes the client device 102 to visit the associated URL. The links may be designated as sponsored links (advertisements), for example. In other implementations, the responsive content comprises other types of content, such as a display advertisement (e.g., image, audio, and/or video) that is to be presented within a content slot of a web page or other information resource.

In one implementation, the techniques disclosed herein are used to facilitate the finding of local services (e.g., professional services). For example, the computing system 104 may receive user queries and attempt to identify whether a user who entered a query is seeking a particular type of local service (e.g., plumbing services, attorney services, tutoring services, music lessons, etc.). When computing system 104 identifies such a query, the computing system 104 can provide result(s) that are more likely to be of interest to the user who entered the query. Identification of such a query may require that the computing system 104 accurately categorize the query, as discussed in further detail below.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable on the processing unit 122 to perform various operations, including the instructions of various software applications and the data generated and/or used by such applications.

In the example implementation of FIG. 1, the memory 124 stores at least an application 130. Generally, the application 130 is executed by the processor 122 to provide one or more user interfaces via display 126, where the user interface(s) enable a user to enter and submit search queries and view the results provided by computing system 104 (or content sponsor 106, etc.). In implementations where the search engine identifies/provides results corresponding to web pages and/or other Internet content, the application 130 may be a web browser application (e.g., with the search engine being available when the user enters/visits Google.com) or a mobile application (e.g., a Google Search mobile application). In other implementations, the application 130 may be any application that provides search functionality based on user-entered queries (e.g., a YouTube application, a service-finding platform application, a social media platform application, etc.). In implementations where the application 130 is a web browser application, the web page may be hosted by computing system 104, with the browser causing the client device 102 to download HTML, scripts, and/or other code of the web page for presentation to a user via the display 126.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the computing system 104 via the network 110. For example, the network interface 120 may include a cellular communication transceiver, a WiFi transceiver, and/or transceivers for one or more other wired and/or wireless communication technologies.

While FIG. 1 shows client device 102 as a single component communicating directly (i.e., via network 110) with the computing system 104, in some implementations the subcomponents of client device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The computing system 104 includes a network interface 140, a processor 142, and memory 144. The network interface 140 includes hardware, firmware, and/or software configured to enable the computing system 104 to exchange electronic data with the client device 102 and other, similar client devices via the network 110. For example, the network interface 140 may include a wired or wireless router and a modem. The processor 142 may be a single processor, or may include two or more processors. Computing system 104 may be a single computing device at a single location, or may include multiple, coordinating computing devices that are either co-located or remotely distributed.

The memory 144 is a computer-readable, non-transitory storage unit or device, or collection of units/devices, that may include persistent and/or non-persistent memory components. The memory 144 stores the instructions of a benchmark query generator 150, a query evaluator 152, a query matcher 154, and a content selector 156, each of which may comprise instructions executed by the processor 142. The benchmark query generator 150 includes a prompt generator module 164, and also includes (or is configured to access) a language model 160. It is understood that, in some implementations, the memory 144 may omit one or more modules/elements shown in FIG. 1, such as query evaluator 152 and/or query matcher 154. In some implementations, query matcher 154 and/or content selector 156 are instead stored in a memory of a separate computing system, such as a search engine server (e.g., if computing system 104 generates benchmark queries but does not match queries and/or select content responsive to user queries).

Generally, the benchmark query generator 150 generates text queries referred to herein as “benchmark” queries, which serve as a “ground truth” for being highly relevant to a particular category. That is, the benchmark query generator 150 generates text queries that are known to be, or accepted as being, highly relevant to a particular category. While the description that follows makes reference to a given query (benchmark or otherwise) being relevant to (or associated with, etc.) a particular “category,” it is understood that, in some implementations, the query may be relevant to (or associated with, etc.), a set of multiple categories that include the particular category.

The benchmark query generator 150 generates the benchmark queries by constructing text prompts (with prompt generator 164) and applying those text prompts as inputs to the language model 160. The language model 160 generally operates on sequences of tokens, and includes layers providing self-attention and feedforward mechanisms that enable the language model 160 to learn/understand contextual relationships between tokens, and to predict upcoming/next tokens in an output token sequence. The language model 160 may include, for example, a large language model (LLM) using a transformer architecture to process a sequence of tokens (e.g., a decoder-only transformer model, or a PaLM (Pathways Language Model), or a GPT (generative pre-trained transformer) model, etc.).

The computing system 104 may train the language model 160 on a knowledge base/corpus, such as by crawling the Internet for general information, and/or obtaining other training information, and applying the training information as input to the language model 160 during an unsupervised training process. This training process may include inputting sequences of tokens to the language model 160, which learns to predict a probability distribution for the next token in the sequence, with model parameters/weights being updated according to an objective function that minimizes the difference between the predicted distribution and a true next token in the training data.

In some implementations, the computing system 104 pre-trains the language model 160 to understand grammar/syntax and general concepts using a more generalized corpus of information, and then fine-tunes the training of the language model 160 using additional, specialized information, such as information contained in a specific database. For example, the computing system 104 may pre-train the language model 160 on a general knowledge base that contains information about the category (e.g., vertical, field, etc.) for which benchmark queries are desired (e.g., by retrieving information from the Internet), and then fine-tune the language model 160 on other information. The fine-tuning information may include, for example, on-line reviews of service providers associated with the category, descriptions of service providers associated with the category, information from web sites of service providers associated with the category, user search queries that have previously been used as triggers to provide results associated with the category (e.g., historical user queries stored in a historical queries database 172), text and/or other content from digital advertisements/creatives of a service provider associated with the category, organic search results that were previously served in response to user queries associated with the category (e.g., stored in historical queries database 172), and/or other information. In an alternative implementation, the computing system 104 trains the language model 160 based on relatively general knowledge, and then uses other information sources of the sort mentioned above (e.g., service provider reviews, service provider web site information, etc.) to construct a text prompt for the language model 160 (e.g., as discussed in further detail below).

In some implementations, the computing system 104 pre-trains and fine-tunes a different language model 160 for each category for which a benchmark query set is desired. In other implementations, fine-tuning is omitted. In some of these latter implementations, the benchmark query generator 150 trains and uses only a single language model 160 to generate sets of benchmark queries associated with different categories.

Training of the language model 160 (e.g., pre-training and/or fine-tuning) can include tuning hyperparameters of the language model 160 and/or other steps. The computing system 104 may also perform validation testing on the trained language model 160 before the language model 160 is put into use.

The benchmark query generator 150 may use or operate the trained language model 160 in different ways, depending on the implementation. For example, the benchmark query generator 150 may initialize the trained language model 160, load parameters into the language model 160, and provide the language model 160 with prompt inputs as discussed below. In some implementations, the benchmark query generator 150 deploys the trained language model 160 onto a cloud computing device such as a server (e.g., using an application programming interface (API)). In other implementations, the language model 160 is trained and maintained by another computing system, and benchmark query generator 150 accesses/uses the trained language model 160 via an API (or web page, etc.).

The prompt generator 164 generates text prompts that the benchmark query generator 150 applies as inputs to the trained language model 160. The prompt generator 164 may generate the text prompt by applying information (e.g., text entered by a user via the computing system 104 or another device or system) to a template, such as by using the user-supplied information to populate one or more fields of the template. In other implementations, the benchmark query generator 150 does not include the prompt generator 164, and prompts are supplied in their entirety by one or more users.

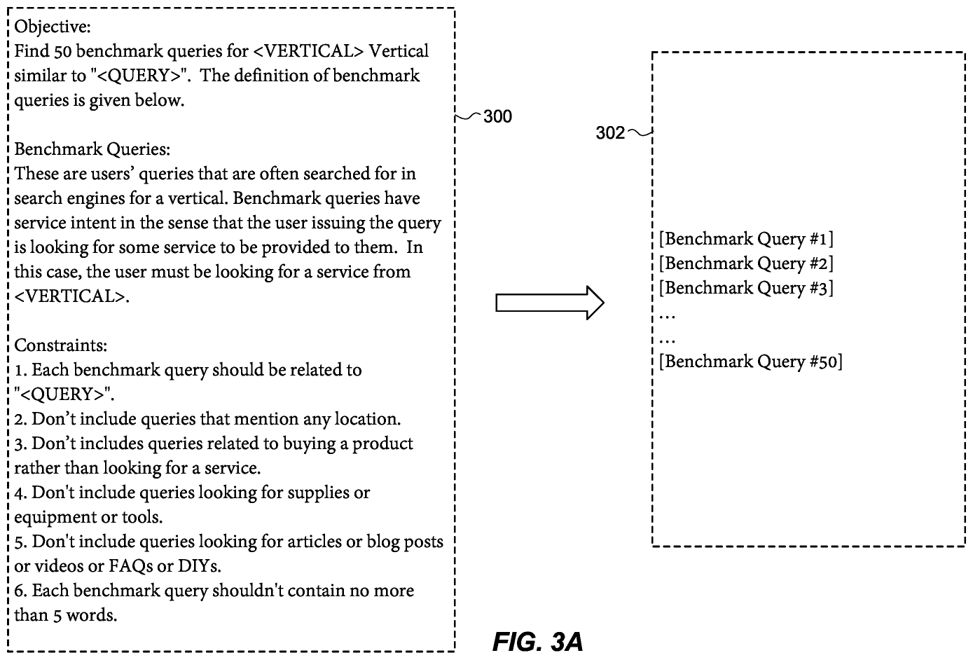

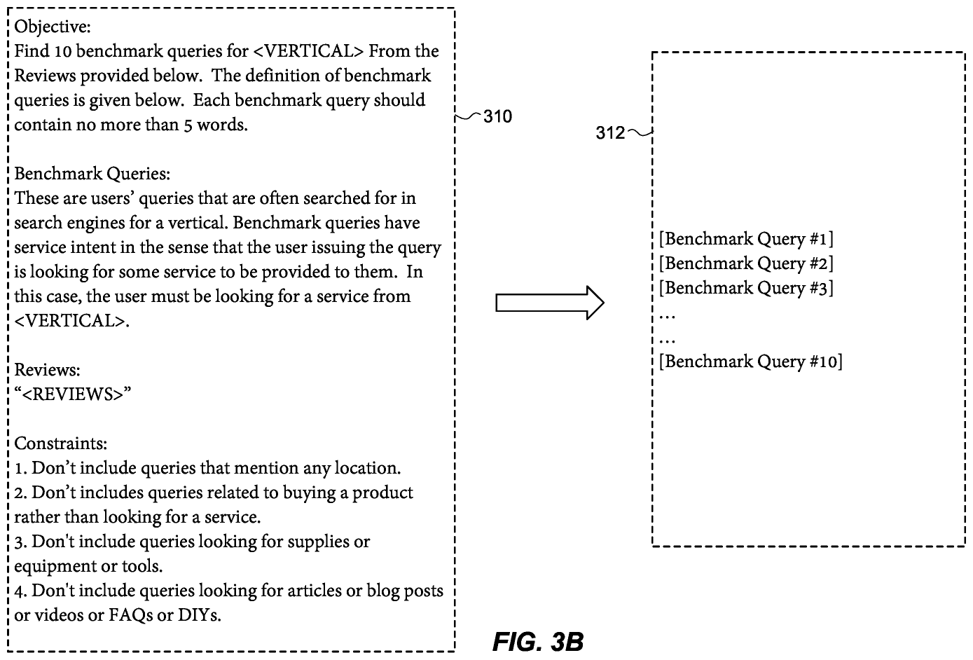

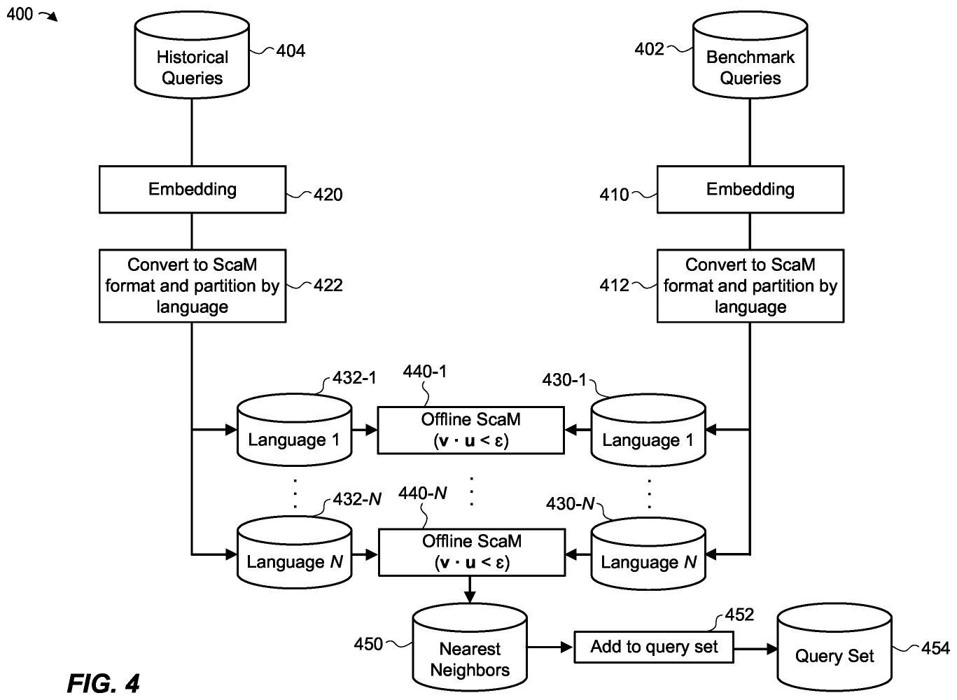

A prompt may specify, for example, the category (e.g., field, vertical, etc.) for which the generated queries are to serve as benchmark queries (e.g., “Generate user queries for plumbing services . . . ”), a description or definition of the type of queries desired (e.g., “Generate user queries . . . that users often search for, using search engines, with the intent of having those services be provided to them . . . ”), and possibly other information such as the number of desired queries (e.g., “Generate 50 search queries for . . . ”). In some implementations, the prompt specifies a number of additional constraints, such as “Do not include queries that mention a location” and/or “Do not include queries that relate to buying a product rather than a service.” Prompt construction is discussed in further detail below with reference to particular examples, e.g., in connection with the examples of FIGS. 3 and 4.

Whether supplied by prompt generator 164 or by a user (or some combination of the two), each text prompt is applied by benchmark query generator 150 as an input to the trained language model 160, which in response generates the requested set of benchmark queries. The benchmark query generator 150 may then store the generated queries in a benchmark queries database 162 for later use (e.g., by content selector 156).

In some implementations, before or after storage in benchmark queries database 162, the benchmark queries generated by benchmark query generator 150 are evaluated/filtered by query evaluator 152. In some implementations, the query evaluator 152 applies various heuristics to evaluate benchmark queries. For example, the query evaluator 152 may determine whether a given benchmark query is likely to perform well based on factors such as the frequency of the query (e.g., query evaluator 152 only keeps queries that, according to historical queries database 172, were entered by users with at least some minimum threshold frequency), other metrics associated with the query (e.g., whether a certain percentage of users who entered the query ultimately used/purchased the services of a provider in the category of that query), and/or the outcome of human consideration/review of the query (e.g., a rating on a scale, or a binary indicator of acceptance or rejection, etc.). The query evaluator 152 may also remove queries with known bad query patterns (e.g., remove queries known to not be associated with a given category), and/or remove queries based on other rules. Such rules may include, for example, determining a set of nearest neighbors for a candidate benchmark query (e.g., using query matcher 154, discussed in further detail below, or another component or module), selecting a sampling of those nearest neighbors for human review/evaluation, and removing/filtering out the candidate benchmark query if the human review concludes that at least a threshold fraction or portion of those sampled neighbors are irrelevant to the category of interest). In some implementations, before and/or after the evaluations noted above, query evaluator 152 (or another module of benchmark query generator 150) also performs other operations to ensure that the generated benchmark queries are acceptable, such as location-normalizing the benchmark queries, spell-correcting the benchmark queries, removing all duplicate queries, and/or removing all queries that are too similar to, or add only marginal value over, one or more other queries in the benchmark query set.

In some implementations, query evaluator 152 (or another component or module) also supplements benchmark queries with additional information, e.g., to enable the benchmark queries to be used in a manner that better serves the intent of a user entering a search query. Examples of such supplemental information, for a particular query, may include a vertical, a locale, and/or a job type with which the query is associated. As a more specific example, query evaluator 152 may supplement the benchmark query (or potential benchmark query) “fix pipe leak” with the job type “fix_leak”. At a later time, computing system 104 or another system may provide advertising content to a user's client device only if (1) the content is a match with the user's search query, e.g., as discussed further below), and (2) the service provider associated with that advertising content provides a service corresponding to that job type (e.g., as determined by query matcher 154 or another component or module based on information that is stored in a database and indicates service providers and their respective job type(s)).

The query matcher 154 is generally configured to map particular user queries (e.g., an incoming query from client device 102, or a past user query stored in historical queries database 172) to one or more other queries (e.g., from among the benchmark queries stored in database 162, or from among a larger set of queries that includes the benchmark queries). This mapping process is also referred to herein as a “matching” process, although a “match” in this context does not necessarily mean that two elements are identical.

The query matcher 154 may perform this mapping/matching for one or more purposes, based on the implementation. For example, the query matcher 154 may compare (e.g., offline before runtime) each benchmark query that was generated by benchmark query generator 164 for a particular category against each of a number of queries (e.g., each of millions or billions of queries) stored in historical queries database 172, and computing system 104 (e.g., module 150 or 154) may add all “matching” queries from the historical queries database 172 to a larger set of queries associated with the category. That is, the computing system 104 expands the set of benchmark queries generated for a particular category, such that the full set of queries associated with the category includes not only the benchmark queries but also a number of additional, sufficiently similar queries from the historical queries database 172. For example, the query matcher 154 may add a past/historical query to a query set for a particular category responsive to the query matcher 154 determining that the past/historical query is a sufficient match with one or more queries in the set of benchmark queries associated with that category. Example techniques for determining a “sufficient” match are discussed in further detail below. In other implementations, the computing system 104 does not expand the set of benchmark queries for a given category.

Additionally or alternatively, the query matcher 154 may, during runtime operation, determine the category with which each incoming search query (e.g., as entered by a user of client device 102 or another client device, and received via network 110) is to be associated, e.g., for purposes of identifying/selecting content (e.g., search results) corresponding to the determined category and providing such content to the client device of the user who entered the search query. In these implementations, the query matcher 154 may compare each incoming search query against each query in a query set associated with a particular category, where the query set may either consist of only the benchmark queries, or include the benchmark queries as well as “expanded” queries from historical queries database 172 (as discussed above). In some implementations, the query matcher 154 makes these comparisons against queries in multiple different query sets associated with multiple respective categories in order to determine which query set (and thus, which category) is a best match for the search query. For example, the query matcher 154 may determine that an incoming query is associated with a particular category responsive to the query matcher 154 determining that the incoming query has a match with a particular query in the query set for that category. Example techniques for determining a match are discussed in further detail below, e.g., in connection with FIG. 4.

The content selector 156 is configured to identify/select content responsive to search queries that are (1) entered by users of client devices such as client device 102, and (2) received from those client devices via network 110. In some implementations, content selector 156 only identifies/selects sponsored content (e.g., digital advertisements). For example, the system 100 may include a separate server or system, not shown in FIG. 1, that provides search result content (e.g., non-sponsored search results/links returned by a conventional online search engine), while computing system 104 provides sponsored content (digital advertisements) that supplements those search results. The content identified/selected by content selector 156 may be any suitable type of content, depending on the implementation. If the user search queries are traditional search engine queries (e.g., entered in the search field of Google Search), for example, the content selector 156 may identify/select search advertisements (e.g., titles, text blurbs, URLs, etc.) that are responsive to each user search query. As another example, if the user search queries are queries entered in a search field of a user interface provided by a dedicated service-finding mobile application, the content selector 156 may identify/select links to service providers/businesses that are responsive to each user search query. As yet another example, if the user search queries are queries entered in a search field of a video sharing application (e.g., YouTube), the content selector 156 may identify/select sponsored video content items that are responsive to each user search query.

The content selector 156 uses the category of an incoming user search query to identify some or all of the content items (e.g., links/URLs, digital advertisements, etc.) that are to be presented as search results to the user who entered the search query. The category may be the category that was determined by the query matcher 154 based on comparisons with the benchmark queries (and possibly also with other, expanded queries in a query set), as discussed above. The content selector 156 may also use other information, in addition to the category, to determine responsive content for the incoming user search query. For example, the content selector 156 may use keyword bid amounts provided by service providers (e.g., content sponsor 106) to perform an automated auction process that determines which content items are to be provided to the user, and/or to determine the order in which those content items are to be provided to the user. As another example, the content selector 156 may apply “brand safety” rules to ensure that certain content items are not presented to the user as search results.

As noted above, in some implementations, the content selector 156 (and possibly query matcher 154 or a portion thereof) is instead stored at and executed by another computing system (e.g., a separate search engine server), rather than computing system 104.

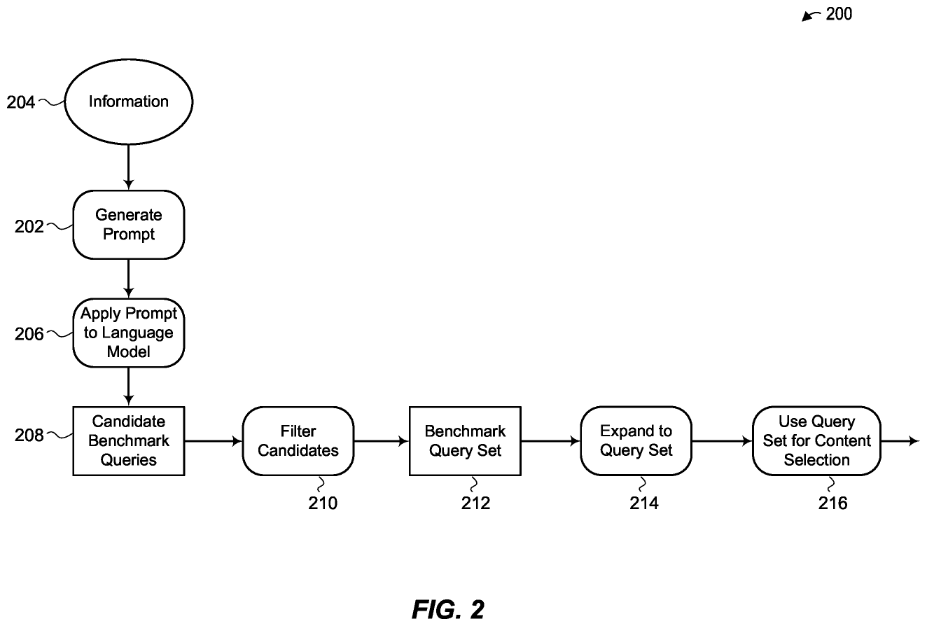

FIG. 2 depicts an example process 200 for generating and using benchmark search queries. The process 200 may be implemented/performed by the computing system 104 of FIG. 1 (e.g., by software stored in memory 144 and executed by the processor 142), or by another computing system. For ease of explanation, the process 200 is explained below with reference to elements of the system 100 of FIG. 1. FIG. 2 assumes that the language model 160 has already been trained (e.g., pre-trained and fine-tuned), although it is understood that the language model 160 can be re-trained/tuned/updated after runtime operation (e.g., based on additional user queries and/or metrics associated with those additional user queries).

At stage 202, prompt generator 164 generates a text prompt for the language model 160 based on information 204. The text prompt asks or instructs the language model 160 to generate benchmark queries for a particular category. The information 204 may include, for example: (1) text reviews of one or more service providers associated with the particular category; (2) service categories of the service providers (e.g., as indicated/stored within a business profile database); (3) content of, or references to (e.g., links/URLs), one or more websites of service providers associated with the particular category; (4) one or more search queries (e.g., from historical queries database 172) known to be associated with the particular category; (5) text content (with image, video, and/or audio content if language model 160 is multimodal) of one or more digital advertisements of one or more service providers associated with the particular category; and/or (6) text content of, or references to, one or more search results (e.g., from historical queries database 172) for one or more search queries associated with the particular category.

The computing system 104 may obtain the information 204 in one or more ways, which can vary depending on the implementation. For example, a user may manually add some or all of information 204 to the prompt. Alternatively, or in addition, prompt generator 164 may automatically retrieve information referenced in the prompt. For example, a prompt may refer to service provider reviews at a particular URL or storage location, which the prompt generator 164 can then access and incorporate into the prompt. As discussed above, the prompt can specify the category and types of queries being sought, and possibly other information such as the desired number of benchmark queries and/or one or more criteria limiting the types of queries to be produced (e.g., constraint(s) that prevent the benchmark queries from being indicative of interest in a particular location, prevent the benchmark queries from being indicative of interest in buying a product rather than a service, prevent the benchmark queries from being indicative of interest in an online publication, and/or prevent the benchmark queries from being indicative of interest in instructions for providing self-service).

At stage 206, benchmark query generator 150 applies the prompt as an input to the language model 160, causing the language model 160 to output a number of candidate benchmark queries 208 for the category of interest. The number may be a number that was specified in the prompt, or the language model 160 may be self-limiting in the number of queries produced.

At stage 210, query evaluator 152 filters out certain ones of the candidate benchmark queries 208, to ensure that any remaining queries are suitable for their intended purpose. Stage 210 may involve applying any suitable rules, heuristics, algorithms, etc., to rule out unsuitable candidate queries. For example, stage 210 may include, for each candidate query, determining whether the query satisfies one or more criteria, and then either retaining the candidate query as a benchmark query (responsive to determining that the query satisfies the one or more criteria) or discarding or ignoring the candidate query (responsive to determining that the query does not satisfy the one or more criteria, or does not satisfy one of multiple criteria, etc.).

The query evaluator 152 may apply any suitable criteria at stage 210, such as a minimum frequency at which the query has been entered by users (e.g., based on information in historical queries database 172) and/or a threshold (e.g., minimum) value for a performance metric indicative of how often users that entered the query selected content associated with the particular category (e.g., based on other information in historical queries database 172).

The candidate queries that remain after stage 210 may constitute the final benchmark query set 212. In the implementation shown in FIG. 2, the query matcher 154 at stage 214 then expands the benchmark query set 212 to a larger query set that, at stage 216, the content selector 156 uses for content selection purposes (i.e., to select appropriate content/results based at least in part on the category for incoming user queries, as that category was determined by comparing those incoming user queries against the expanded query set), as discussed above. The query matcher 154 may accomplish the expansion at stage 214 using the techniques discussed below in connection with FIG. 4, for example. In other implementations, stage 214 is omitted, and only the benchmark queries are used by the content selector 156 at stage 216.

In some implementations the process 200 includes other stages not shown in FIG. 2, such as removing location-specific information associated with (contained in) the benchmark queries.

FIGS. 3A and 3B depict example prompts that may be used (e.g., input to the trained language model 160) to generate benchmark queries. Referring first to FIG. 3A, an example prompt 300 causes the language model 160 to build a set of benchmark queries 302 based on an exemplary query (e.g., a query from historical queries database 172, or associated with a service category from a provider's business profile, that is known to be entered by users when they are highly interested in the category for which benchmark queries are being generated). As seen in FIG. 3A, the example prompt 300 includes an objective statement, where “<VERTICAL>” is replaced/populated with the category for which benchmark queries are being generated and “<QUERY>” is replaced/populated with the exemplary query being used as a basis for generating other benchmark queries. The prompt 300 also includes a definitional statement to provide, to language model 160, the meaning of the term “benchmark queries.” The prompt 300 also includes a number of constraints limiting the type of queries that the language model 160 should generate.

FIG. 3B depicts another example prompt 310, which causes the language model 160 to build a set of benchmark queries 312 based on reviews of a service provider associated with the category (here, the vertical) for which benchmark queries are being generated. As seen in FIG. 3B, the example prompt 310 includes an objective statement, where “<VERTICAL>” is replaced/populated with the category for which benchmark queries are being generated and “<REVIEWS>” is replaced/populated with reviews (e.g., online customer reviews) of service providers known to be associated with the vertical. The prompt 310 also includes a definitional statement to provide to language model 160 the meaning of the term “benchmark queries,” and a number of constraints limiting the type of queries that the language model 160 should generate.

As discussed above, query matcher 154 may compare or match queries for one or more purposes, depending on the implementation. FIG. 4 depicts an example process 400 that may be performed by query matcher 154 to compare/match historical queries 404 (e.g., in historical queries database 172) to benchmark queries 402 (e.g., of query set 212). For example, the process 400 may occur at stage 214 of FIG. 2.

At stage 410, query matcher 154 uses a first trained machine learning model (e.g., neural network) to embed each benchmark query as a vector (e.g., a sequence of 32 numbers, or 64 numbers, etc.). At stage 412, query matcher 154 converts the vectors to a scalable nearest neighbor matching (ScaM) format, and partitions the formatted vectors by language (e.g., English, Spanish, German, etc.). Similarly at stage 420, query matcher 154 uses a different, second trained machine learning model (e.g., neural network) to embed each historical query as a vector (e.g., a sequence of 32 numbers, or 64 numbers, etc.), and at stage 422 query matcher 154 converts the vectors to a ScaM format and partitions the formatted vectors by language (e.g., English, Spanish, German, etc.). In an alternative implementation, the same machine learning model is used at stages 410 and 420. For more efficient performance, the query matcher 154 may run batch inference processes at stages 410 and 420, using any suitable tool or platform (e.g., TensorFlow, PyTorch, etc.).

In the example of FIG. 4, query matcher 154 partitions the embeddings/vectors for the historical queries 404 and the embeddings/vectors for the benchmark queries 402 into N different languages, where N is any suitable integer greater than one (e.g., two, five, eight, etc.). The vectors for the benchmark queries 402 are represented in FIG. 4 as vector sets 430-1 through 430-N, and the vectors for the historical queries 404 are represented in FIG. 4 as vector sets 432-1 through 432-N. In an alternative implementation, the vectors are not partitioned by language.

In the depicted example, query matcher 154 determines which historical queries 404 match a given benchmark query 402 using an offline ScaM process, at stages 440-1 through 440-N (i.e., only attempting to match vectors that correspond to queries of the same language). Performing the ScaM process after partitioning by language can greatly increase the processing efficiency, e.g., potentially increasing the rate at which query sets are processed by 600% or more as compared to non-partitioned query sets.

The query matcher 154 may determine that a given historical query “matches” a given benchmark query if the distance between the vectors corresponding to the two queries is less than a threshold distance & (e.g., if the dot product of the two vectors is less than &). In some implementations, the query matcher 154 enforces a maximum number of permissible matches for any given benchmark query. Query matcher 154 may check whether all possible pairs formed from historical queries 404 and benchmark queries 402 are a match, or may use any suitable techniques to limit the number of pairs that are checked (e.g., discontinuing checks with benchmark queries of a particular query set after a first match is found).

The process 400 may include additional stages not shown in FIG. 4. For example, queries may be converted to the format of a particular platform (e.g., TensorFlow, PyTorch, etc.) before stages 410 and 420, and may use any suitable feature set (e.g., a feature set that includes at least the query and an indicator of the query language). As another example, the query matcher 154 may annotate the benchmark queries 402 and historical queries 404 with related terms using any suitable techniques, algorithms, etc., and then perform the embedding of stages 410 and 420 on the expanded/annotated set of terms. For example, the annotation may include annotating each query with words known to have some association with, and provide additional context to, terms or phrases in the query (e.g., to provide a so-called “bag of words” representation of each query).

Query matcher 154 saves the historical queries that match at least one of the benchmark queries 402 as nearest neighbors 450, and adds 452 those matching historical queries to an expanded query set 454 that includes both the benchmark queries and the matching historical queries. Query matcher 154 may repeat the process 400 for each category of interest (i.e., with the benchmark queries 402 of each iteration being the set of benchmark queries for a different category).

In an alternative implementation, the process 400 is instead used at runtime to match incoming user search queries against each query of the benchmark query set 212. For example, historical queries 404 may instead represent user search queries arriving over some time period, stages 440-1 through 440-N may be real-time processes, and stages 450 through 452 may be replaced by a stage in which query matcher 154 determines whether the incoming query should be associated with a particular category (i.e., the category with which benchmark queries 402 are associated).

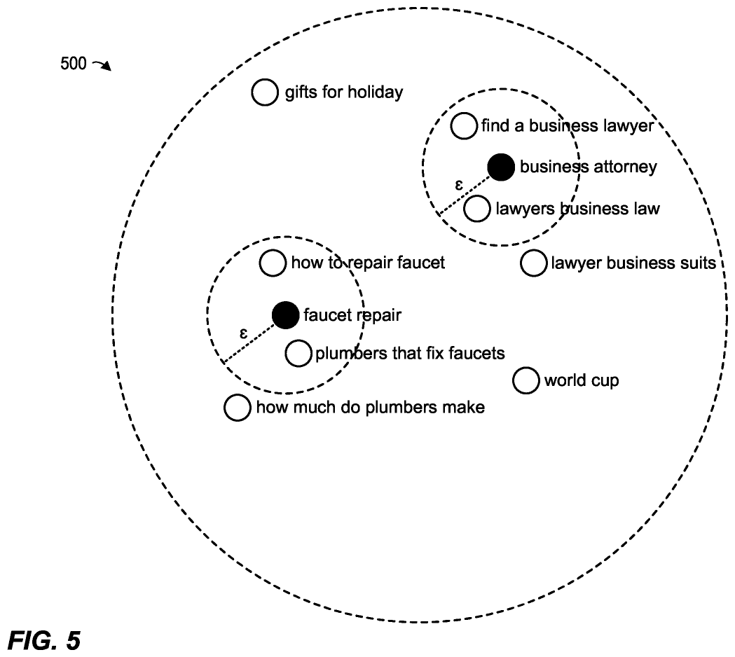

FIG. 5 depicts a simplified (reduced-dimensionality) representation of an example vector space 500 for matching search queries. The vector space 500 may be the space in which the vectors 430-1 and 432-1 reside, for example. In FIG. 5, the filled/solid circles represent benchmark queries, and the empty circles represent historical or incoming user queries that query matcher 154 compares to the benchmark queries. As seen in FIG. 5, for example, the queries “how to repair faucet” and “plumbers that fix faucets” are matches to (i.e., correspond to vectors within distance & of the vector of) the benchmark query “faucet repair,” while “how much do plumbers make” narrowly avoids being a match, and “gifts for holiday” is far from being a match.

In some implementations, query matcher 154 not only categorizes incoming user search queries (e.g., using the process 400), but also determines a sub-category for the incoming query. For example, query matcher 154 may use process 400 (or another suitable process) to determine that an incoming user query is associated with the vertical (category) “daycare,” and then use another process to determine that the incoming user query is associated with the job type (sub-category) “infant programs.” Query matcher 154 may use any suitable technique to determine the sub-category. For example, each benchmark query in a query set for a category may be associated with a particular sub-category, and query matcher 154 may associate an incoming query with the sub-category for the benchmark query that has an embedding/vector that is closest to an embedding/vector for the incoming query (e.g., as calculated stage 440-1). Other techniques are also possible, such as associating the incoming query with the sub-category of the benchmark query that has a highest cosine similarity (as calculated for the embeddings/vectors of the incoming query and the benchmark query). The content selector 156 may use the sub-category to help identify the content to provide responsive to a user's search query, instead of or in addition to the category.

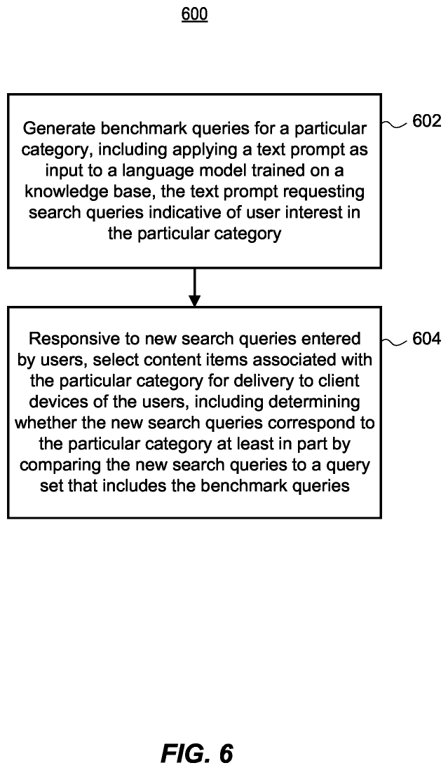

FIG. 6 is a flow diagram of an example method 600 for facilitating content selection. The method 600 may be implemented by the computing system 104 (e.g., benchmark query generator 150 and content selector 156) of FIG. 1, for example.

At block 602, benchmark queries for a particular category are generated. Block 602 includes applying a text prompt (e.g., prompt 300 or 310) as input to a language model trained on a knowledge base (e.g., language model 160). The text prompt (e.g., prompt 300 or 310) requests search queries indicative of user interest in the particular category.

At block 604, responsive to new search queries entered by users, content items associated with the particular category are selected for delivery to client devices of the users (e.g., client device 102). Block 604 includes determining whether the new search queries correspond to the particular category (and possibly a particular sub-category, etc.), at least in part by comparing the new search queries to a query set that includes the benchmark queries (e.g., benchmark query set 212, the query set after the expansion of stage 214, or query set 454).

The method 600 may include one or more additional blocks. For example, the method 600 may include additional blocks in which, for each query of the benchmark queries 402, it is determined that the query satisfies one or more criteria (e.g., the criteria applied at stage 210), and, responsive to determining that the query satisfies the one or more criteria, the query is retained as a benchmark query. As another example, the method 600 may include an additional block in which the content items selected at bock 604 are provided to the client devices.

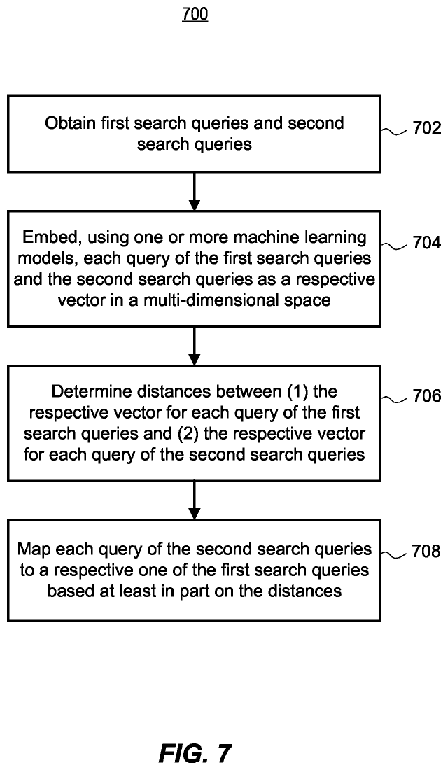

As another example, the method 600 may include an additional block in which the benchmark queries are expanded to the query set, at least in part by mapping each of a plurality of search queries to a respective one of the benchmark queries. The mapping may include: (1) using one or more machine learning models to embed each of the plurality of search queries and each of the benchmark queries as a respective vector in a multi-dimensional space; (2) determining distances between the respective vector for each of the plurality of queries and the respective vector for each of the benchmark queries; and (3) mapping each of the plurality of search queries to the respective one of the benchmark queries based at least in part on the distances. In some implementations, the mapping is performed according to the process 400 of FIG. 4, and/or the method 700 of FIG. 7 discussed below.

FIG. 7 is a flow diagram of an example method 700 for search query matching. The method 700 may be implemented by the computing system 104 (e.g., query matcher 154) of FIG. 1, for example.

At block 702, first search queries (e.g., benchmark queries 402 or a subset thereof) and second search queries (e.g., historical queries 404 or a subset thereof, or incoming user search queries) are obtained (e.g., received or fetched). At block 704, one or more machine learning models are used to embed each query of the first search queries and the second search queries as a respective vector in a multi-dimensional space (e.g., stages 410 and 420). At block 706, distances between (1) the respective vector for each query of the first search queries, and (2) the respective vector for each query of the second search queries, are determined. At block 708, each query of the second search queries is mapped to a respective one of the first search queries based at least in part on the distances determined at block 708.

The method 700 may include one or more additional blocks. For example, the method 700 may include an additional block in which content items are selected for delivery to client devices based at least in part on the categories associated with the second search queries. Further, the method 700 may include an additional block in which the selected content items are provided to the client devices.

It is understood that the blocks of FIGS. 6 and 7 need not be performed strictly in the order shown. For example, blocks 702 through 708 may overlap in time, with earlier queries being embedded as later queries are received, etc.

In some implementations, the techniques disclosed herein use artificial intelligence to facilitate the selection of content items. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 104 may use any one or more the machine learning models noted above to perform any one or more of the operations discussed herein in connection with machine learning. For example, the computing system 104 may use one or more such machine learning models to generate benchmark queries or to match queries, as discussed above.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1. A method of facilitating content selection, the method comprising: generating, by a computing system, benchmark queries for a particular category, wherein generating the benchmark queries includes applying a text prompt as input to a language model trained on a knowledge base, and wherein the text prompt requests search queries indicative of user interest in the particular category; and selecting, by the computing system and responsive to new search queries entered by users, content items associated with the particular category for delivery to client devices of the users, wherein selecting the content items includes determining whether the new search queries correspond to the particular category at least in part by comparing the new search queries to a query set that includes the benchmark queries.

Example 2. The method of example 1, wherein the knowledge base includes Internet information regarding the particular category.

Example 3. The method of example 1, wherein the text prompt includes text reviews of one or more service providers associated with the particular category.

Example 4. The method of example 1, wherein the text prompt includes content of, or references, one or more websites of service providers associated with the particular category.

Example 5. The method of example 1, wherein the text prompt includes one or more search queries known to be associated with the particular category.

Example 6. The method of example 1, wherein the text prompt includes text content of one or more digital advertisements of one or more service providers associated with the particular category.

Example 7. The method of example 1, wherein the text prompt includes text content of, or references, one or more search results for one or more search queries associated with the particular category.

Example 8. The method of example 1, wherein the text prompt includes one or more constraints on the benchmark queries, the one or more constraints preventing the benchmark queries from including one or more of: any benchmark query indicative of interest in a particular location; any benchmark query indicative of interest in buying a product rather than a service; any benchmark query indicative of interest in an online publication; or any benchmark query indicative of interest in instructions for providing self-service.

Example 9. The method of example 1, further comprising, for each query of the benchmark queries: determining, by the computing system, that the query satisfies one or more criteria; and responsive to determining that the query satisfies the one or more criteria, retaining, by the computing system, the query as a benchmark query.

Example 10. The method of example 9, wherein the one or more criteria include one or both of: satisfying a minimum frequency at which the query is entered by users; and satisfying a threshold value for a performance metric indicative of how often users that enter the query select content associated with the particular category.

Example 11. The method of example 9, wherein generating the benchmark queries includes removing location-specific information associated with the benchmark queries.

Example 12. The method of example 1, wherein the benchmark queries are a subset of the query set, and wherein the method further comprises: expanding, by the computing system, the benchmark queries to the query set, at least in part by mapping each of a plurality of search queries to a respective one of the benchmark queries.

Example 13. The method of example 12, wherein mapping each of the plurality of search queries to a respective one of the benchmark queries includes: using one or more machine learning models to embed each of the plurality of search queries and each of the benchmark queries as a respective vector in a multi-dimensional space; determining distances between the respective vector for each of the plurality of queries and the respective vector for each of the benchmark queries; and mapping each of the plurality of search queries to the respective one of the benchmark queries based at least in part on the distances.

Example 14. The method of example 1, wherein generating the benchmark queries is performed by a first server of the computing system, and wherein selecting the content items for delivery to the client devices is performed by a second server of the computing system.

Example 15. The method of example 1, further comprising: providing, by the computing system, the selected content items to the client devices.

Example 16. A computing system comprising: one or more processors; and one or more non-transitory, computer-readable memories storing instructions that, when executed by the one or more processors, cause the computing system to perform the method of any one of examples 1-15.

Example 17. A non-transitory, computer-readable medium storing instructions that, when executed by one or more processors of a computing system, cause the computing system to perform the method of any one of examples 1-15.

Example 18. A method of search query matching, the method comprising: obtaining, by a computing system, first search queries and second search queries; embedding, by the computing system and using one or more machine learning models, each query of the first search queries and the second search queries as a respective vector in a multi-dimensional space; determining, by the computing system, distances between (i) the respective vector for each query of the first search queries and (ii) the respective vector for each query of the second search queries; and mapping, by the computing system, each query of the second search queries to a respective one of the first search queries based at least in part on the distances.

Example 19. The method of example 18, wherein each query of the first search queries is associated with a respective category, and wherein the method further comprises: associating, by the computing system, each query of the second search queries with the respective category of the search query, of the first search queries, to which the query is mapped.

Example 20. The method of example 19, further comprising: selecting, by the computing system, content items for delivery to client devices based at least in part on the categories associated with the second search queries.

Example 21. The method of example 20, further comprising: providing, by the computing system, the selected content items to the client devices.

Example 22. The method of example 18, wherein obtaining the first search queries and the second search queries includes: obtaining a set of benchmark queries and a set of historical user search queries; expanding the set of benchmark queries to the first search queries; and expanding the set of historical user search queries to the second search queries.

Example 23. The method of example 22, wherein the mapping is further based on cosine distances between at least a portion of the first search queries and at least a portion of the second search queries.

Example 24. The method of example 18, wherein obtaining the first search queries and the second search queries includes: obtaining a set of benchmark queries; obtaining incoming user search queries over a time period; expanding the set of benchmark queries to the first search queries; and expanding, over the time period, the incoming user search queries to the second search queries, wherein the embedding, the determining, and the mapping occur over the time period.

Example 25. The method of example 18, wherein determining the distances includes determining distances only between the vectors for queries that share a same language.

Example 26. A computing system comprising: one or more processors; and one or more non-transitory, computer-readable memories storing instructions that, when executed by the one or more processors, cause the computing system to perform the method of any one of examples 18-26.

Example 27. A non-transitory, computer-readable medium storing instructions that, when executed by one or more processors of a computing system, cause the computing system to perform the method of any one of examples 18-25.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for facilitating content selection through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method of facilitating content selection, the method comprising:
generating, by a computing system, benchmark queries for a particular category, wherein generating the benchmark queries includes applying a text prompt as input to a language model trained on a knowledge base, and wherein the text prompt requests search queries indicative of user interest in the particular category; and
selecting, by the computing system and responsive to new search queries entered by users, content items associated with the particular category for delivery to client devices of the users, wherein selecting the content items includes determining whether the new search queries correspond to the particular category at least in part by comparing the new search queries to a query set that includes the benchmark queries.

2. The method of claim 1, wherein the knowledge base includes Internet information regarding the particular category.

3. The method of claim 1, wherein the text prompt includes text reviews of one or more service providers associated with the particular category.

4. The method of claim 1, wherein the text prompt includes content of, or references, one or more websites of service providers associated with the particular category.

5. The method of claim 1, wherein the text prompt includes one or more search queries known to be associated with the particular category.

6. The method of claim 1, wherein the text prompt includes text content of one or more digital advertisements of one or more service providers associated with the particular category.

7. The method of claim 1, wherein the text prompt includes text content of, or references, one or more search results for one or more search queries associated with the particular category.

8. The method of claim 1, wherein the text prompt includes one or more constraints on the benchmark queries, the one or more constraints preventing the benchmark queries from including one or more of:
any benchmark query indicative of interest in a particular location;
any benchmark query indicative of interest in buying a product rather than a service;
any benchmark query indicative of interest in an online publication; or
any benchmark query indicative of interest in instructions for providing self-service.

9. The method of claim 1, further comprising, for each query of the benchmark queries:
determining, by the computing system, that the query satisfies one or more criteria; and
responsive to determining that the query satisfies the one or more criteria, retaining, by the computing system, the query as a benchmark query.

10. The method of claim 9, wherein the one or more criteria include one or both of:
satisfying a minimum frequency at which the query is entered by users; and
satisfying a threshold value for a performance metric indicative of how often users that enter the query select content associated with the particular category.

11. The method of claim 9, wherein generating the benchmark queries includes removing location-specific information associated with the benchmark queries.

12. The method of claim 1, wherein the benchmark queries are a subset of the query set, and wherein the method further comprises:
expanding, by the computing system, the benchmark queries to the query set, at least in part by mapping each of a plurality of search queries to a respective one of the benchmark queries.

13. The method of claim 12, wherein mapping each of the plurality of search queries to a respective one of the benchmark queries includes:
using one or more machine learning models to embed each of the plurality of search queries and each of the benchmark queries as a respective vector in a multi-dimensional space;
determining distances between the respective vector for each of the plurality of search queries and the respective vector for each of the benchmark queries; and
mapping each of the plurality of search queries to the respective one of the benchmark queries based at least in part on the distances.

14. The method of claim 1, wherein generating the benchmark queries is performed by a first server of the computing system, and wherein selecting the content items for delivery to the client devices is performed by a second server of the computing system.

15. The method of claim 1, further comprising:
providing, by the computing system, the selected content items to the client devices.

16. A computing system comprising:
one or more processors; and
one or more non-transitory, computer-readable memories storing instructions that, when executed by the one or more processors, cause the computing system to
generate benchmark queries for a particular category, wherein generating the benchmark queries includes applying a text prompt as input to a language model trained on a knowledge base, and wherein the text prompt requests search queries indicative of user interest in the particular category and
select, responsive to new search queries entered by users, content items associated with the particular category for delivery to client devices of the users, wherein selecting the content items includes determining whether the new search queries correspond to the particular category at least in part by comparing the new search queries to a query set that includes the benchmark queries.

17. The computing system of claim 16, wherein the text prompt includes one or more of:
text reviews of one or more service providers associated with the particular category;
content of, or references, one or more websites of service providers associated with the particular category;
one or more search queries known to be associated with the particular category;
text content of one or more digital advertisements of one or more service providers associated with the particular category; or
text content of, or references, one or more search results for one or more search queries associated with the particular category.

18. The computing system of claim 16, wherein the text prompt includes one or more constraints on the benchmark queries, the one or more constraints preventing the benchmark queries from including one or more of:
any benchmark query indicative of interest in a particular location;
any benchmark query indicative of interest in buying a product rather than a service;
any benchmark query indicative of interest in an online publication; or
any benchmark query indicative of interest in instructions for providing self-service.

19. The computing system of claim 16, wherein:
the instructions further cause the computing system to, for each query of the benchmark queries,
determine that the query satisfies one or more criteria, and
responsive to determining that the query satisfies the one or more criteria, retain the query as a benchmark query; and
the one or more criteria include one or both of
satisfying a minimum frequency at which the query is entered by users, and
satisfying a threshold value for a performance metric indicative of how often users that enter the query select content associated with the particular category.

20. The computing system of claim 16, wherein:
the benchmark queries are a subset of the query set;
the instructions further cause the one or more processors to expand the benchmark queries to the query set, at least in part by mapping each of a plurality of search queries to a respective one of the benchmark queries; and
mapping each of the plurality of search queries to a respective one of the benchmark queries includes
using one or more machine learning models to embed each of the plurality of search queries and each of the benchmark queries as a respective vector in a multi-dimensional space,
determining distances between the respective vector for each of the plurality of search queries and the respective vector for each of the benchmark queries, and
mapping each of the plurality of search queries to the respective one of the benchmark queries based at least in part on the distances.

21. A method of search query matching, the method comprising:
obtaining, by a computing system, first search queries and second search queries;
embedding, by the computing system and using one or more machine learning models, each query of the first search queries and the second search queries as a respective vector in a multi-dimensional space;
determining, by the computing system, distances between (i) the respective vector for each query of the first search queries and (ii) the respective vector for each query of the second search queries; and
mapping, by the computing system, each query of the second search queries to a respective one of the first search queries based at least in part on the distances.
